(19) United States
(12) Patent Application Publication
(10) Pub. No.: US 2004/0105929 A1
(43) Pub. Date: Jun. 3, 2004

(54) Instant fried noodles with lowered acrylamide and method of preparing the same

(75) Inventors: Yoshio Tomoda, Tokyo (JP); Akihiro Hanaoka, Chiba-shi (JP); Toshitaka Yasuda, Kawasaki-shi (JP); Tomo Takayama, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: TOYO SUISAN KAISHA, LTD., Tokyo (JP)

(21) Appl. No.: 10/705,613

(22) Filed: Nov. 10, 2003

(30) Foreign Application Priority Data
Nov. 13, 2002 (JP) 2002-329795
May 30, 2003 (JP) 2003-155655

(51) Int. Cl. A23L 1/00

(52) U.S. Cl. 426/557

(57) ABSTRACT

Instant fried noodles with lowered acrylamide. This fried noodles may be prepared by a method comprising kneading a mixture of raw materials containing a cereal flour to prepare noodle dough, preparing strands of noodle with the noodle dough, and frying the strands of noodle to prepare fried noodles, wherein pH of the noodle dough and/or pH of the strands of noodle before the frying is so controlled that a pH value of the fried noodles is 6.5 or less.

### CROSS-REFERENCE TO RELATED APPLICATIONS

This application is based upon and claims the benefit of priority from the prior Japanese Patent Applications No. 2002-329795, filed Nov. 13, 2002; and No. 2003-155655, filed May 30, 2003, the entire contents of both of which are incorporated herein by reference.

### BACKGROUND OF THE INVENTION

1. Field of the Invention

The present invention relates to a method for preparing instant fried noodles with lowered acrylamide and such instant fried noodles.

2. Description of the Related Art

In the manufacturing method of instant noodles, cereal flour such as wheat flour is used as a main raw material. Water and additives such as salt are added to the raw material for kneading the raw material so as to prepare noodle dough. Further, the dough is stretched using rollers and cut so as to obtain strands of the noodle. The strands of noodle thus prepared are steamed and, then, seasoned, as required, followed by cutting the strands of noodle into short pieces having a desired length, weighing the cut pieces for one meal, and drying the weighed pieces of the strands of noodle by frying the strands of noodle and/or blowing a hot air to the strands of noodle so as to obtain the instant noodles.

In recent years, traces of components which were not detected in the past, included in the components contained in various substances, have come to be detected due to the progress of analysis equipment. For example, a Swedish researcher reports that traces of acrylamide are formed by the cooking under heat of a livestock feed, as disclosed in, for example, “Chemical Research in Toxicology 13”: pp. 517-522 (2000). Also, a British researcher reports that asparagine, which is the main amino acid of potato and cereals, is mainly involved in the formation of acrylamide, as reported in, for example, “Nature” 419, pp. 448-450 (2002).

The present inventors also considered that, since cereals are used as the raw materials of noodles that are handled in their business, it may be possible for acrylamide to be formed in the fried noodles and have begun to conduct research into acrylamide formation.

### BRIEF SUMMARY OF THE INVENTION

Accordingly, objects of the present invention are to provide a method for preparing instant fried noodles with lowered acrylamide and to provide such instant fried noodles.

The present inventors have found that the pH value of the fried noodles, which was conventionally about at least 6.8, can be decreased to 6.5 or less by controlling the pH value of the strands of noodle immediately before the frying process so as to make it possible to prepare instant fried noodles with lowered acrylamide.

The above objects of the present invention were achieved by the means given below.

(1) A method for preparing instant fried noodles comprising kneading a mixture of raw materials containing a cereal flour to prepare noodle dough, preparing strands of the noodle with the noodle dough, and frying the strands of noodle to prepare fried noodles, wherein pH of the noodle dough and/or pH of the strands of noodle before the frying is so controlled that a pH value of the fried noodles is 6.5 or less, thereby preparing the instant fried noodles with lowered acrylamide.

(2) The method for preparing instant fried noodles as defined in item (1) above, wherein the pH of the noodle dough is controlled by kneading the mixture of raw materials in the presence of at least one pH-controlling agent, and/or by applying an acidic aqueous solution to the noodle dough and/or the strands of noodle before the frying.

(3) The method for preparing instant fried noodles as defined in item (2) above, wherein the pH-controlling agent is capable of decreasing the pH value of the noodle dough, and the acidic aqueous solution is capable of decreasing the pH value of the noodle dough and/or the strands of noodle.

(4) The method for preparing instant fried noodles as defined in item (1) above, wherein a pH value of the strands of noodle before the frying is controlled by kneading the mixture of raw materials in the presence of at least one additive having a low buffering ability to change in pH of the mixture of raw materials, and by applying an acidic solution to the noodle dough and/or the strands of noodle before frying.

(5) Instant fried noodles prepared by the method described in any one of items (1) to (4).

Additional objects and advantages of the present invention will be set forth in the description which follows, and in part will be obvious from the description, or may be learned by practice of the present invention. The objects and advantages of the present invention may be realized and obtained by means of the instrumentalities and combinations particularly pointed out hereinafter.

### DETAILED DESCRIPTION OF THE INVENTION

A method for preparing instant fried noodles with lowered acrylamide will now be described in detail.

The instant fried noodles with lowered acrylamide, which are prepared by the method of the present invention, are characterized in that the pH value of the noodles after frying is not larger than 6.5 in order to decrease the amount of acrylamide contained in the fried noodles.

Herein, “the pH value of the noodles after frying is not larger than 6.5” means that the pH value of the noodles at least immediately after the frying process during the preparation process of the instant fried noodles, is not larger than 6.5.

The lower limit of the pH value of the fried noodles is not particularly limited in the present invention as far as the acrylamide content in the fried noodles is not larger than a prescribed amount and, thus, the lower limit of the pH value can be determined appropriately in view of the texture, flavor, taste, etc., of the fried noodles as the product. For example, it is possible for the lower limit of the pH value to be 4 or more. As far as the pH value of the noodles immediately after the frying process is not larger than 6.5, it is inconceivable for the amount of acrylamide to be lowered even if the pH value of the fried noodles is caused to exceed 6.5 by some factors and, thus, fried noodles having a pH value exceeding 6.5 is acceptable as the fried noodle product.

The instant fried noodles of the present invention with lowered acrylamide can be prepared basically in line with the ordinary method. However, it is necessary in the manufacturing method of the instant fried noodles of the present invention to control the pH value of the noodles after the frying process to be 6.5 or less.

To be more specific, in the method of the present invention for manufacturing the instant fried noodles with lowered acrylamide, the raw materials including a cereal flour is kneaded first so as to prepare noodle dough.

The raw materials used for preparing the noodle dough include main raw materials of cereal flours such as wheat flour (for example, strong flour, mellower strong flour, soft flour and durum semolina) and a rice powder. In general, water, salt and other additives are included in the raw materials together with the cereal flour. The other additives noted above are not particularly limited as far as the pH value of the fried noodles is 6.5 or less, thereby the amount of acrylamide is lowered. Depending on the kinds of the noodles, it is possible to use various additives that can be used as the food additives such as “kansui”, plant proteins, egg powder, a yam powder, an emulsifying agent, a thickening polysaccharide and a colorant.

The term “kansui” referred to above denotes a substance or a mixture of a plurality of substances prepared by using as raw materials potassium carbonate, sodium carbonate, sodium hydrogencarbonate, potassium salt or sodium salt of phosphoric acids as well as an aqueous solution thereof or a dilution thereof with wheat flour, as specified in the official regulation document on the food additive based on Food Sanitation Law of Japan.

In the instant fried noodles with lowered acrylamide, which are prepared by the method of the present invention, it is possible to use “kansui” satisfying the requirements of the regulation of the components described above as far as the conditions described below are satisfied. It is also possible to use a substitute substance as far as the substitute substance performs the same function as “kansui”. Further, it is possible to use “kansui” in combination with the substitute substance referred to above.

The mixing ratio of the cereal flour, salt, water and the other additives is not particularly limited in the present invention as far as the noodles after the frying have a pH value not greater than 6.5 and the content of acrylamide in the instant fried noodles prepared by the method of the invention is lowered.

The raw materials used for preparing the noodle dough containing the cereal flour, salt, water and, as required, the other additives can be kneaded by the ordinary method so as to obtain the noodle dough.

The noodle dough thus obtained is, for example, stretched using rollers so as to obtain a noodle sheet, followed by cutting the noodle sheet into strands of the noodle. Alternatively, the noodle sheet can be processed into strands of the noodle by using an extruder. In the next step, the strands of noodle are subjected in general to the steaming process and, then, to the moisture conditioning process, as required, so as to control the water content of the strands of noodle. Further, the noodles are seasoned, cut into strands of the noodle having a prescribed length, and, then, dried by the frying.

One of the features of the present invention for manufacturing the instant fried noodles with lowered acrylamide is that the pH value of the strands of noodle immediately before the frying process is controlled to a prescribed value or less. By controlling the pH value, generation of acrylamide during the frying process is prevented or suppressed.

The present inventors are of the opinion that, if the pH value of the strands of noodle immediately before the frying process is controlled to a prescribed value or less, the pH value of the noodles during the frying process is also lowered to a prescribed value or less, with the result that it is possible to suppress the generation of acrylamide. In this case, it suffices for the pH value of the strands of noodle immediately before the frying process to be rendered equal to or smaller than a prescribed value by changing upward or downward or by maintaining the pH value of the strands of noodle before the control. In the present invention, to “control the pH value” of the noodle dough and/or the strands of noodle includes the case where the buffering ability to the change in pH of the noodle dough and/or the strands of noodle is changed.

The pH value of the strands of noodle immediately before the frying process may be set such that the pH value of the noodles after the frying process is not larger than 6.5. According to the research conducted by the present inventors, there is relation between the pH value of the noodles after the frying process and the pH value of the noodles immediately before the frying process. For example, in order to set the pH value of the noodles at 6.5 after the frying process, it suffices to set the pH value of the noodles at about 7 immediately before the frying process, though the pH value of the noodles immediately before the frying process is not necessarily limited to this.

In order to set the pH value of the noodles at 6.5 or less after the frying process by controlling the pH value of the noodle dough and/or the strands of noodle in the process of preparing the strands of noodle, it is possible to employ the first method or the second method described below, though the present invention is not limited to these first and second methods.

<First Method>

The first method comprises the steps of:

(a) kneading the raw materials containing cereal flour in the presence of at least one pH value-controlling agent (hereinafter also referred to as a first additive); and/or

(b) applying an acidic aqueous solution to the noodle dough and/or the strands of noodle before the frying process.

The kind and the amount of the first additive used in step (a) given above are not particularly limited as far as the first additive permits decreasing the pH value of the fried noodles to 6.5 or less when used singly or in combination with step (b) given above. It is possible to use a single kind of a compound as the first additive or to use a plurality of different kinds of compounds as a group of the first additives.

The first additives used in the present invention include, for example, carbonates (e.g., potassium carbonate, sodium hydrogencarbonate, and sodium carbonate) and phosphates (e.g., potassium pyrophosphate, sodium pyrophosphate, sodium polyphosphate, sodium metaphosphate, tripotassium phosphate, trisodium phosphate, disodium hydrogenphosphate and sodium dihydrogenphosphate), though the first additives used in the present invention are not limited to these compounds.

It is possible to permit the pH value of the noodle dough after the kneading process to be increased, decreased or maintained by the addition of the first additive, compared with the case where the first additive is not used.

Where a mixture of a carbonate and a phosphate is used as the first additive, it is possible to increase the pH value of the noodle dough by increasing the mixing ratio of the carbonate. On the other hand, it is possible to decrease the pH value of the noodle dough by decreasing the mixing ratio of the carbonate.

The amount of the first additive(s) used in the present invention can be generally set at 0.3 wt. % based on the cereal flour, though the amount of the first additive(s) is not limited to this value.

In the first method of the present invention, step. (b) comprises applying an acidic aqueous solution to the noodle dough and/or the strands of noodle before the frying process.

Step (b) can be performed in combination with step (a) or can be employed alone.

The method of applying an acidic aqueous solution to the noodle dough and/or the strands of noodle is not particularly limited. For example, the acidic aqueous solution can be applied by, for example, showering or dipping.

The acidic aqueous solution can be applied any time desired as far as the acidic aqueous solution is applied before the frying process. For example, the acidic aqueous solution can be applied before, during or after the kneading process, the rolling process, the cutting process, the steaming process, the moisture conditioning process or the seasoning process. It is desirable to apply the acidic aqueous solution during the seasoning process in view of, for example, the manufacturing cost and the convenience in the applying process of the acidic aqueous solution.

Generally, the seasoning process, which is carried out after the steaming process and, as desired, after the moisture conditioning process, is carried out before the frying process. The seasoning process is applied to the noodles by showering of an aqueous solution of seasoning components such as soy sauce, sodium glutamate and protein hydrolyzate or by the dipping in the aqueous solution noted above.

It is possible for the aqueous solution used in step (b) to contain acidic substances such as organic acids (e.g., lactic acid, citric acid, phytic acid, malic acid, ascorbic acid and erythrobic acid) and phosphates (e.g., sodium metaphosphate and sodium acid pyrophosphate, which is also called disodium dihydrogenpyrophosphate). It should be noted that where acidic substances such as soy sauce and a protein hydrolyzate are contained in the seasoning components, they can be regarded as the acidic substance used in step (b) under the condition that the pH value of the noodles after the frying process is rendered not larger than 6.5.

The kind and the amount of the acidic substance, which differ depending on whether the acidic substance is used in step (a) as well as in step (b) and or whether the acidic substance is used in step (b) alone, can be selected appropriately such that the pH value of the fried noodles is rendered not larger than 6.5. For example, where the acidic substance is used in step (a) as well as in step (b) and where the pH value of the noodle dough is sufficiently decreased in step (a), the pH value need not be greatly decreased by the application of the acidic aqueous solution in step (b). On the other hand, where pH value of the noodle dough is not sufficiently decreased in step (a), it is possible to lower greatly the pH value by the application of the acidic aqueous solution in step (b). Since there is a certain relationship between the pH value of the noodles after the frying process and that of the noodles immediately before the frying process as described previously, it is possible to select the kind and amount of the acidic substance in view of the relationship noted above. For example, it is possible to use a 1.0 wt. % aqueous solution of lactic acid.

<Second Method>

The second method for allowing the pH value of the fried noodles to be not larger than 6.5 by controlling the pH value of the noodle dough and/or strands of the noodle in the manufacturing process of the strands of noodle will now be described.

The second method comprises the steps of:

(c) kneading the raw materials containing cereal flour in the presence of an additive (hereinafter also referred to as a second additive) having a low buffering ability to a change in the pH of the mixture; and

(d) applying an acidic aqueous solution to the noodle dough and/or the strands of noodle before the frying process.

The second additive used in step (c) is characterized in that the second additive exhibits a low buffering ability to a change in the pH of the noodle dough.

The “additive having a low buffering ability to a change in the pH of the mixture” herein means that the second additive renders the ability to maintain the pH of the mixture low or the second additive renders the mixture unable to maintain the pH. To be more specific, when the mixture contains the second additive having a low buffering ability the acidic aqueous solution to be used in the subsequent step (d) more easily decrease the pH value of the mixture, compared with the case where the second additive is not used.

Specifically, the second additives include the carbonates (e.g., potassium carbonate, sodium hydrogencarbonate and sodium carbonate) included in the first additives referred to previously, though the second additives are not limited to these carbonates. It is possible for the second additives to include the phosphates (e.g., potassium pyrophosphate, sodium pyrophosphate, sodium polyphosphate and sodium metaphosphate). However, in view of the aspect of lowering the buffering ability, it is desirable for the second additive to contain a small amount of the phosphate or not to contain the phosphate at all. The small amount herein means that the amount of the phosphate is small enough so as not to increase the buffering ability compared with the case where the phosphate is not used.

It is possible to use the second additive or a group of the second additives in an amount of generally 0.1 wt. % based on the cereal flour, though the amount of the second additive or the second additive group is not limited to the value noted above.

In the second method, steps (c) and (d) are employed in combination.

The acidic aqueous solution equal to that used in step (b) described previously in conjunction with the first method is used in the step (d). The method, amount and the timing of application of the acidic aqueous solution of the step (d) are also the same as those in step (b). In the second method, however, the second additive having a low buffering ability is kneaded in the noodle dough in step (c) and, thus, the pH value of the noodle dough and/or the strands of noodle can be easily decreased in the second method even if the amount of the acid used in the step (d) is smaller than that in the step (b) of the first method. For example, it is possible to use a 0.3 wt. % aqueous solution of sodium acid pyrophosphate.

### EXAMPLE

Some Examples of the present invention will now be described, though the present invention is not limited to these Examples.

In the following Examples, the expression “%” denotes. “% by weight”.

Comparative Example 1 given below is a comparative example commonly corresponding to the first and second methods of the present invention. The results are shown herein later in Tables 1 and 2.

### Comparative Example 1

Five kg of wheat flour, and 1.6 kg of water, to which 76 g of salt and 16.4 g of “kansui” (i) were added and stirred, were charged to a mixer and kneaded for 18 minutes so as to obtain noodle dough. “Kansui” (i) contained 40% of potassium carbonate, 27% of sodium carbonate, 18% of sodium metaphosphate, 10% of sodium polyphosphate, 4% of sodium dihydrogenphosphate, and 1% of sodium pyrophosphate.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution containing 5.72% of salt and 1.34% of sodium glutamate and having a pH value of 6.80.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

Example 1 given below is an example of the present invention commonly corresponding to the first and second methods of the present invention. The results are shown herein later in Tables 1 and 2.

### Example 1

Five kg of wheat flour, and 1.6 kg of water, to which 76 g of salt and 16.4 g of “kansui” (i) were added and stirred, were charged to a mixer and kneaded for 18 minutes so as to obtain noodle dough. “Kansui” (i) contained 40% of potassium carbonate, 27% of sodium carbonate, 18% of sodium metaphosphate, 10% of sodium polyphosphate, 4% of sodium dihydrogenphosphate, and 1% of sodium pyrophosphate.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 3.99) containing 5.72% of salt, 1.34% of sodium glutamate, and 1.0% of lactic acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

Examples 2 to 9 given below are examples of the present invention commonly corresponding to the first method of the present invention. The results are shown herein later in Table 1.

### Example 2

Five kg of wheat flour, and 1.6 kg of water, to which 76 g of salt and 11.41 g of “kansui” (ii) were added and stirred, were charged to a mixer and kneaded for 18 minutes so as to obtain noodle dough. “Kansui” (ii) contained 53% of potassium carbonate, 26% of sodium metaphosphate, 14% of sodium polyphosphate, 6% of sodium dihydrogenphosphate, and 1% of sodium pyrophosphate.

The noodle dough thus obtained was stretched using rollers by the ordinary method, so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 4.98) containing 5.72% of salt, 1.34% of sodium glutamate, and 0.10% of lactic acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 3

Five kg of wheat flour, and 1.6 kg of water, to which 76 g of salt and 16.4 g of “kansui” (iii) were added and stirred, were charged to a mixer and kneaded for 18 minutes so as to obtain noodle dough. “Kansui” (iii) contained 46% of potassium carbonate, 40% of sodium metaphosphate, 10% of sodium polyphosphate, and 4% of sodium dihydrogenphosphate.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt, and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 4

Five kg of wheat flour, and 1.6 kg of water, to which 76 g of salt and 12.9 g of “kansui” (iv) were added and stirred, were charged to a mixer and kneaded for 18 minutes so as to obtain noodle dough. “Kansui” (iv) contained 58% of potassium carbonate and 42% of sodium metaphosphate.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 6.80) containing 5.72% of salt, and 1.34% of sodium glutamate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 5

Five kg of wheat flour, and 1.6 kg of water, to which 76 g of salt and 16.4 g of “kansui” (i) were added and stirred, were charged to a mixer and kneaded for 18 minutes so as to obtain noodle dough. “Kansui” (i) contained 40% of potassium carbonate, 27% of sodium carbonate, 18% of sodium metaphosphate, 10% of sodium polyphosphate, 4% of sodium dihydrogenphosphate and 1% of sodium pyrophosphate.

The noodle dough thus obtained was stretched using rollers by the ordinary method sodas to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 3.40) containing 5.72% of salt, 1.34% of sodium glutamate and 1.0% of malic acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 6

Five kg of wheat flour, and 1.6 kg of water, to which 76 g of salt and 16.4 g of “kansui” (i) were added and stirred, were charged to a mixer and kneaded for 18 minutes so as to obtain noodle dough. “Kansui” (i) contained 40% of potassium carbonate, 27% of sodium carbonate, 18% of sodium metaphosphate, 10% of sodium polyphosphate, 4% of sodium dihydrogenphosphate and 1% of sodium pyrophosphate.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 3.68) containing 5.72% of salt, 1.34% of sodium glutamate and 1.0% of phytic acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 7

Five kg of wheat flour, and 1.6 kg of water, to which 76 g of salt and 16.4 g of “kansui” (i) were added and stirred, were charged to a mixer and kneaded for 18 minutes so-as to obtain noodle dough. “Kansui” (i) contained 40% of potassium carbonate, 27% of sodium carbonate, 18% of sodium metaphosphate, 10% of sodium polyphosphate, 4% of sodium dihydrogenphosphate and 1% of sodium pyrophosphate.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 3.50) containing 5.72% of salt, 1.34% of sodium glutamate and 1.0% of citric acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 8

Five kg of wheat flour, and 1.6 kg of water, to which 76 g of salt and 16.4 g of “kansui” (i) were added and stirred, were charged to a mixer and kneaded for 18 minutes so as to obtain noodle dough. “Kansui” (i) contained 40% of potassium carbonate, 27% of sodium carbonate, 18% of sodium metaphosphate, 10% of sodium polyphosphate, 4% of sodium dihydrogenphosphate, and 1% of sodium pyrophosphate.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 3.93) containing 5.72% of salt, 1.34% of sodium glutamate and 2.0% of ascorbic acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 9

Five kg of wheat flour, and 1.6 kg of water, to which 76 g of salt and 16.4 g of “kansui” (i) were added and stirred, were charged to a mixer and kneaded for 18 minutes so as to obtain noodle dough. “Kansui” (i) contained 40% of potassium carbonate, 27% of sodium carbonate, 18% of sodium metaphosphate, 10% of sodium polyphosphate, 4% of sodium dihydrogenphosphate and 1% of sodium pyrophosphate.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 3.85) containing 5.72% of salt, 1.34% of sodium glutamate and 2.0% of erythrobic acid.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

Examples 10 to 13 given below are examples of the present invention corresponding to the second method of the present invention. The results are shown herein later in Table 2.

### Example 10

Five kg of wheat flour, and 1.6 kg of water, to which 76 g of salt and 6.7 g of potassium carbonate were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 4.67) containing 5.72% of salt, 1.34% of sodium glutamate and 0.30% of sodium metaphosphate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 11

Instant fried noodles placed in the cup were prepared by the same method as in Example 10, except that the seasoning solution used contained 5.72% of salt, 1.34% of sodium glutamate and 0.25% of lactic acid and exhibited a pH value of 4.55.

### Example 12

Five kg of wheat flour, and 1.6 kg of water, to which 76 g of salt and 5.1 g of sodium carbonate were added and stirred, were charged to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 5.24) containing 5.72% of salt, 1.34% of sodium glutamate and 0.30% of sodium acid pyrophosphate.

Further, these strands of the noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Example 13

Five kg of wheat flour, and 1.6 kg of water, to which 76 g of salt and 5.1 g of sodium hydrogencarbonate were charged and stirred, were added to a mixer and kneaded for 18 minutes so as to obtain noodle dough.

The noodle dough thus obtained was stretched using rollers by the ordinary method so as to obtain a dough sheet having a thickness of 0.77 mm and, then, the dough sheet was cut by a square cutting roll No. 20 so as to obtain strands of the noodle having a width of 1.5 mm.

These strands of noodle were steamed for 90 seconds by the ordinary method, followed by spraying a seasoning solution (pH 5.24) containing 5.72% of salt, 1.34% of sodium glutamate and 0.30% of sodium acid pyrophosphate.

Further, these strands of noodle were cut into a prescribed length and shaped into a molding block, followed by frying the cut strands of noodle at 150° C. for 120 seconds with palm oil, thereby obtaining fried noodles. Then, the fried noodles were put in a cup, followed by housing a soup into the cup and subsequently sealing the cup so as to obtain instant fried noodles placed in the cup.

### Measuring Example 1

The amount of acrylamide (AA) contained in the fried noodles prepared in Example 1 was measured by the method given below.

<Measuring Method of Acrylamide Content of Fried Noodles>

(i) Extraction from Noodles

Ten g of pulverized noodle sample immediately after the frying was weighed, and a prescribed amount of a heavy hydrogen labeled acrylamide was added to the sample as an internal standard substance. As the standard addition segment, acrylamide and heavy hydrogen labeled acrylamide were added to the same amount of the noodle sample. Distilled water in an amount of 100 mL (milliliters) was added to each of these samples and, after homogenization and extraction by shaking for 5 minutes, the supernatant separated by the centrifugal operation was recovered. Then, a distilled water in an amount of 60 mL was added to the residue of the sample, followed by extraction by shaking and separation by centrifugation two times so as to obtain the separated supernatant liquid. Further, the supernatant liquid thus obtained was subjected to the suction filtration so as to obtain about 200 mL of the extracted liquid.

(ii) Bromination of Extracted Acrylamide

About 250 mL of the extracted liquid having the pH value adjusted with sulfuric acid was quantitatively separated in accordance with the measuring method of acrylamide monomer specified in “Guide Line of Test Method for Evaluating the City Water Chemicals” published in March, 2000 by the Waterworks Maintenance Section, Waterworks Environment Department of the Livelihood Bureau, the former Ministry of Health and Welfare. Then, 100 g of potassium boride was dissolved in the extracted liquid thus separated.

Further, 12.5 mL of 0.2M potassium bromate solution was added for carrying out the reaction for 60 minutes so as to achieve the bromination.

(iii) Debromination from Reaction Mixture

The free bromine was removed by adding 1M sodium thiosulfate drop-wise immediately after 60 minutes.

(iv) Extraction of Brominated Acrylamide

The total amount of the bromination reaction mixture and 25 mL of ethyl acetate were put in a separatory funnel, and the funnel was allowed to stand still after vibration for 5 minutes so as to recover the ethyl acetate layer. Then, 10 mL of ethyl acetate was added to the residual water layer, followed by recovering the ethyl acetate layer. The operations described above were carried out twice so as to obtain about 45 mL of the solvent extracted liquid in a centrifugal tube.

(v) Dehydration of Extracted Solvent

The solvent extracted liquid was centrifuged so as to remove the water layer, and 10 g of anhydrous sodium sulfate was added to the ethyl acetate layer. After the residue was allowed to stand still for 30 minutes, the residue was dehydrated and, then, filtered.

(vi) Condensation of Solvent Extracted Liquid

The solvent extracted liquid was condensed to about 5 mL by using a rotary evaporator, followed by adding ethyl acetate up to a constant volume of 10 mL, thereby obtaining a solution for examination.

(vii) Measurement of Acrylamide by GC-MS

A part of the solution for examination thus obtained was taken out, and triethylamine was added to the solution for examination. After the mixed solution was left to stand for 20 minutes, the GC-MS analysis was applied. The acrylamide content was calculated from the area ratio of the heavy hydrogen labeled acrylamide added as an internal standard substance to acrylamide.

The instant fried noodles with lowered acrylamide specified in the present invention, which can be achieved by decreasing the pH value of the strands of noodle immediately before the frying process to a value smaller than a prescribed value, denotes the acrylamide content lower than the acrylamide content of the instant fried noodles which may be arrived at in the case where the pH value of the strands of noodle is not adjusted.

The AA (acrylamide) content of the fried noodles obtained in each of the other Examples and Comparative Example 1 was measured in the same way.

### Measuring Example 2

The pH value of the noodle dough before the seasoning in Example 1 was measured as follows.

Specifically, 20 g of the noodle dough after the kneading process was weighed and put in a beaker, followed by adding 200 mL of an ion-exchanged water to noodle dough so as to homogenize the noodle dough. After the homogenized noodle dough was left to stand for 30 minutes, the pH value was measured at 20° C. to 25° C. with a HORIBA Kastani LAB table top pH meter M-12.

The pH value of the noodle dough before the seasoning for each of the other Examples and Comparative Example 1 was measured in the same way.

### Measuring Example 3

The pH value of the strands of noodle after the seasoning in Example 1 was measured as follows.

Specifically, 20 g of the frozen strands of noodle after the seasoning process was weighed and put in a beaker, followed by adding 200 mL of an ion-exchanged water to the strands of noodle so as to homogenize the strands of noodle. After the homogenized strands of noodle were left to stand for 30 minutes, the pH value was measured at 20° C. to 25° C. with a HORIBA Kastani LAB table top pH meter M-12.

The pH value of the strands of noodle after the seasoning for each of the other Examples and Comparative Example 1 was measured in the same way.

### Measuring Example 4

The pH value of the noodles after the frying process in Example 1 was measured as follows.

Specifically, 20 g of the noodles after the frying process was weighed and put in a beaker, followed by adding 200 mL of an ion-exchanged water to noodles so as to homogenize the noodles. After the homogenized noodles were left to stand for 30 minutes, the pH value was measured at 20° C. to 25° C. with a HORIBA Kastani LAB table top pH meter M-12.

The pH value of the noodles after the frying process for each of the other Examples and Comparative Example 1 was measured in the same way.

The mixing conditions, the pH value and the acrylamide (AA) content, etc. of the instant fried noodles obtained in each of Comparative Example 1 and Examples 1 to 13 are shown in Table 1-1, Table 1-2 and Table 2 given below:

TABLE 1-1
The first method

| | Comparison | | | | |
|---|---|---|---|---|---|
| | 1 | Example 1 | Example 2 | Example 3 | Example 4 |
| Blending condition | | | | | |
| <Main raw material> | | | | | |
| Wheat flour | 5.0 kg | 5.0 kg | 5.0 kg | 5.0 kg | 5.0 kg |
| <Sub-raw material> | | | | | |
| Refined salt | 76 g | 76 g | 76 g | 76 g | 76 g |
| “Kansui” (i) | 16.4 g | 16.4 g | | — | — |
| “Kansui” (ii) | — | — | 11.41 g | — | — |
| “Kansui” (iii) | — | — | — | 16.4 g | — |
| “Kansui” (iv) | — | — | — | — | 12.9 g |
| <Seasoning component> | | | | | |
| Refined salt | 57.2 g | 57.2 g | 57.2 g | 57.2 g | 57.2 g |
| Sodium glutamate | 13.4 g | 13.4 g | 13.4 g | 13.4 g | 13.4 g |
| Lactic acid | — | 10 g | 1.0 g | — | — |
| Water | 1.0 L | 1.0 L | 1.0 L | 1.0 L | 1.0 L |
| pH value after seasoning | 8.3 | 6.56 | 6.51 | 6.64 | 6.75 |
| pH value after frying | 7.3 | 6.45 | 6.21 | 6.36 | 6.41 |
| Analyzed AA value | 100 | 74 | 26 | 29 | 32 |
| (ppb) | | | | | |

TABLE 1-2

| | Example 5 | Example 6 | Example 7 | Example 8 | Example 9 |
|---|---|---|---|---|---|
| Blending condition | | | | | |
| <Main raw material> | | | | | |
| Wheat flour | 5.0 kg | 5.0 kg | 5.0 kg | 5.0 kg | 5.0 kg |
| <Sub-raw material> | | | | | |
| Refined salt | 76 g | 76 g | 76 g | 76 g | 76 g |
| “Kansui” (i) | 16.4 g | 16.4 g | 16.4 g | 16.4 g | 16.4 g |
| <Seasoning component> | | | | | |
| Refined salt | 57.2 g | 57.2 g | 57.2 g | 57.2 g | 57.2 g |
| Sodium glutamate | 13.4 g | 13.4 g | 13.4 g | 13.4 g | 13.4 g |
| Malic acid | 10 g | — | — | — | — |
| Phytic acid | — | 10 g | — | — | — |
| Citric acid | — | — | 10 g | — | — |
| Ascorbic acid | — | — | — | 20 g | — |
| Erythrobic acid | — | — | — | — | 20 g |
| Water | 1.0 L | 1.0 L | 1.0 L | 1.0 L | 1.0 L |
| pH value after seasoning | 5.99 | 7.05 | 6.4 | 6.52 | 6.43 |
| pH value after frying | 5.26 | 6.3 | 5.53 | 5.66 | 5.74 |
| Analyzed AA value (ppb) | 37 | 66 | 51 | 77 | 74 |

TABLE 2

| | Comparison 1 | Example 1 | Example 10 | Example 11 | Example 12 | Example 13 |
|---|---|---|---|---|---|---|
| Blending condition | | | | | | |
| <Main raw material> | | | | | | |
| Wheat flour | 5.0 kg | 5.0 kg | 5.0 kg | 5.0 kg | 5.0 kg | 5.0 kg |
| <Sub-raw material> | | | | | | |
| Refined salt | 76 g | 76 g | 76 g | 76 g | 76 g | 76 g |
| “Kansui” (i) | 16.4 g | 16.4 g | — | — | — | — |
| Potassium carbonate | — | — | 6.7 g | 6.7 g | — | — |
| Sodium carbonate | — | — | — | 5.1 g | — | |
| Sodium hydrogencarbonat | — | — | — | — | 5.1 g | |
| <Seasoning component> | | | | | | |
| Refined salt | 57.2 g | 57.2 g | 57.2 g | 57.2 g | 57.2 | g 57.2 g |
| Sodium glutamate | 13.4 g | 13.4 g | 13.4 g | 13.4 g | 13.4 | g 13.4 g |
| Sodium metaphosphate | — | — | 3.0 g | — | — | — |
| Sodium acid pyrophosphate | — | — | — | 3.0 g | 3.0 g | |
| Lactic acid | — | 10 g | — | 2.5 g | — | — |
| Water | 1.0 L | 1.0 L | 1.0 L | 1.0 L | 1.0 L | 1.0 L |
| pH value of noodle dough | 7.99 | 7.99 | 7.65 | 7.65 | 7.66 | 7.14 |
| Acid degree of | | | | | | |
| seasoning solution | 0.03% | 0.7% | 0.2% | 0.2% | 0.2% | 0.2% |
| (in terms of lactic acid) | | | | | | |
| pH value after seasoning | 8.3 | 6.56 | 7.05 | 7.01 | 7.07 | 6.94 |
| pH value after frying | 7.3 | 6.45 | 6.37 | 6.45 | 6.49 | 6.25 |
| Analyzed AA value (ppb) | 100 | 74 | 25 | 22 | 24 | 34 |

As apparent from the experimental data given in Tables 1-1 and 1-2, the pH value of the noodles after the frying process can be decreased to 6.5 or less by (a) kneading the raw materials with at least one kind of a pH control agent added thereto and/or (b) by applying an acidic aqueous solution to the noodle dough and/or the strands of noodle before the frying process so as to make it possible to provide a method for preparing instant fried noodles with lowered acrylamide.

Also, as apparent from the experimental data given in Table 2, the acrylamide content can be efficiently decreased by using an acid solution of a low concentration in the case of using the second additive having exhibiting low performance in the buffering ability so as to make it possible to prepare instant fried noodles without sour taste as well as low in the acrylamide content.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for preparing instant fried noodles comprising kneading a mixture of raw materials containing a cereal flour to prepare noodle dough, preparing strands of the noodle with the noodle dough, and frying the strands of noodle to prepare fried noodles, wherein pH of the noodle dough and/or pH of the strands of noodle before the frying is so controlled that a pH value of the fried noodles is 6.5 or less, thereby preparing the instant fried noodles with lowered acrylamide.

2. The method for preparing instant fried noodles according to claim 1, wherein the pH value of the noodle dough is controlled by kneading the mixture of raw materials in the presence of at least one pH-controlling agent, and/or by applying an acidic aqueous solution to the noodle dough and/or the strands of noodle before the frying.

3. The method for preparing instant fried noodles according to claim 2, wherein the pH-controlling agent is capable of decreasing the pH value of the noodle dough, and the acidic aqueous solution is capable of decreasing the pH value of the noodle dough and/or the strands of noodle.

4. The method for preparing instant fried noodles according to claim 3, wherein the pH-controlling agent is selected from the group consisting of carbonate and phosphate.

5. The method for preparing instant fried noodles according to claim 4, wherein the carbonate is selected from the group consisting of potassium carbonate, sodium hydrogencarbonate, and sodium carbonate, and the phosphate is selected from the group consisting of potassium pyrophosphate, sodium pyrophosphate, sodium polyphosphate, sodium metaphosphate, tripotassium phosphate, trisodium phosphate, disodium hydrogenphosphate and sodium dihydrogenphosphate.

6. The method for preparing instant fried noodles according to claim 2, wherein the acidic aqueous solution contains an organic acid selected from the group consisting of lactic acid, citric acid, phytic acid, malic acid, ascorbic acid and erythrobic acid; and/or a phosphate selected from the group consisting of sodium metaphosphate and sodium acid pyrophosphate.

7. The method for preparing instant fried noodles according to claim 1, wherein the pH value of the strands of noodle before the frying is controlled by kneading the mixture of raw materials in the presence of at least one additive having a low buffering ability to a change in pH of the mixture of raw materials, and by applying an acidic solution to the noodle dough and/or the strands of noodle before frying.

8. The method for preparing instant fried noodles according to claim 7, wherein the additive having a low buffering ability is a carbonate selected from the group consisting of potassium carbonate, sodium hydrogencarbonate and sodium carbonate; and/or a phosphate selected from the group consisting of potassium pyrophosphate, sodium pyrophosphate, sodium polyphosphate and sodium metaphosphate.

9. The method for preparing instant fried noodles according to claim 8, wherein the additive having a low buffering ability is the carbonate selected from the group consisting of potassium carbonate, sodium hydrogencarbonate and sodium carbonate, and a small amount of the phosphate selected from the group consisting of potassium pyrophosphate, sodium pyrophosphate, sodium polyphosphate and sodium metaphosphate.

10. The method for preparing instant fried noodles according to claim 9, wherein the additive having a low buffering ability is one or more kinds of the carbonate alone.

11. Instant fried noodles with lowered acrylamide prepared by the method according to claim 1.
